(19) United States
(12) Patent Application Publication
(10) Pub. No.: US 2017/0231863 A1
(43) Pub. Date: Aug. 17, 2017

(54) eORG's Sexual Stimulating System

(71) Applicant: Shane Murray, Saskatoon (CA)

(72) Inventor: Shane Murray, Saskatoon (CA)

(21) Appl. No.: 15/044,817

(22) Filed: Feb. 16, 2016

(51) Int. Cl. A61H 19/00; A61H 23/02

(52) U.S. Cl. CPC A61H 19/30; A61H 19/34; A61H 19/40; A61H 23/02; A61H 2201/1207; A61H 2201/1628

(57) ABSTRACT

The present invention provides a vibratory device used by holding in hand for general massage of skin as well as stimulation of erogenous zones. The vibratory device generally comprises a body, a vibrating plate positioned on the lower end of the body, a hand grip region at the upper end of the body. A speed controller is provided near the hand grip to control the speed of vibration. The vibratory device further can have a massage pad removably attached to the vibrating plate to absorb the vibrations. A soft elastomeric material such as CyberSkin can be removably attached to the massage pad for providing enhanced stimulation and sensitivity to the skin. The vibratory device provides stimulating erogenous zones directly on the skin or over the clothes in the crotch area for sexual exploration. The vibratory device allows easy control of the intensity and frequency of vibrations.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of Invention

The present invention generally relates to a vibratory device. More particularly, the present invention relates to “a vibratory device useful for general massage of skin as well as stimulating erogenous zones directly on the skin or over the clothes in the crotch area for sexual exploration”.

(2) Background of Invention

Many types of sexual stimulation devices are available to allow users for achieving sexual satisfaction by stimulation of erogenous zones. Some of these devices are operated manually while others may include a vibrating mechanism to also provide vibrations for application on the skin primarily in the crotch area. The sexual stimulation devices employing vibrating mechanism can be useful for stimulating both male and female anatomy. For stimulating erogenous zones, the vibrations may be applied externally to the penis, clitoris and internally to the vagina. For example, U.S. patent application Ser. No. 10/797,643 A discusses a U-shaped implement including a motor causing vibrational motion to allow the implement's use as a stimulation aid. Similarly, U.S. Pat. No. 6,027,444 A issued to Multicept Aps on 2000 Feb. 22, discloses a vibrator comprising including an electric motor, an engagement face adapted to engage a part of a body, a self-supply power unit and a frequency regulating device for supplying upward and downward movement of the engagement face to the engaged part of the body. Also, U.S. Pat. No. 8,409,120 A issued to Jorg Knyrim on 2013 Apr. 2, discloses a massaging device with an elongated massaging recess for receiving a male genital organ for massaging the male genital organ. However, these devices suffer from one or more limitation. Some of these devices can be used only with the male genital organ or female genital organ. Other devices have to be used by directly contacting the male genital organ or female genital organ and cannot function from over the clothes. Also, the vibration provided by some of these devices is very high and interferes with the general massage or erogenous pleasure. Hence, it is desired that a vibratory device is provided which can be used directly on the skin as well as over the clothes for providing stimulation to erogenous zones. Also, it is desired to allow the use of the device for stimulation of erogenous sites as well as general massage of skin. Further, it is desired that the device provides a method to control the intensity and frequency of vibrations.

It is an aspect of the invention to overcome or alleviate a problem of the prior art.

This permits the use of the present invention which enhances the prior art of the vibratory device for providing effective massage or stimulation of erogenous zones both by direct contact with skin as well as over clothes.

### BRIEF SUMMARY OF THE INVENTION

In view of the foregoing, one aspect of the various disclosed embodiments in the present invention is to provide a vibratory device useful for general massage of skin as well as stimulating erogenous zones directly on the skin or over the clothes in the crotch area for sexual exploration.

Preferably the vibratory device addresses or at least ameliorates one or more of the problems described above. To this end, the present invention related to a vibratory device, with some unique aspects is disclosed.

Accordingly, it is a primary object of the present invention to provide a vibratory device useful for general massage of skin as well as stimulating erogenous zones. The vibratory device includes a vibrating plate which is operated by a battery or an external power supply.

It is another object of the present invention that the vibratory device provides stimulating erogenous zones directly on the skin or over the clothes in the crotch area for sexual exploration.

It is another object of the present invention that the vibratory device allows easy control of the intensity and frequency of vibrations.

It is still another object of the present invention that the vibratory device is provided in different shapes and designs for user friendliness.

Other objects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 shows perspective view of a vibratory device;

FIG. 2 shows a perspective view of a vibratory device with silicone layer;

FIG. 3 shows a perspective view of another embodiment of a vibratory device;

### DETAIL DESCRIPTION OF THE INVENTION

The following detailed description of the present invention is the enabling teaching of the invention and its best, currently known embodiment. Those skilled in the art can understand that many changes can be made in to the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made and may be desired in certain circumstances, and are part of the present invention. Thus, the following description is provided as illustrative of the principle of the present invention.

Embodiments of the present invention provide a vibratory device useful for general massage of skin as well as stimulating erogenous zones directly on the skin or over the clothes in the crotch area for sexual exploration. Accordingly, the specific embodiments discussed herein are merely illustrative of specific manners in which to make and use this invention and are not intended to represent an exhaustive list of all possible structure and processes of the present invention.

Embodiments of the vibratory device are shown in the figures and discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

Aspects of the present inventive subject matter are described with reference to the figures.

The present invention provides a vibratory device that may be held in the hand while the vibratory device is useful for generating vibration to be applied to a skin. The vibratory device can also be used for stimulating erogenous zones directly on the skin or over the clothes in the crotch area for sexual exploration. For example, the vibratory device can be used to apply vibration on penis directly on the skin or over the clothes. The vibratory device provides stimulatory sensation to penis or clitoris for pleasure and achieving orgasm. The vibratory device is specifically useful in erectile dysfunction, major erectile dysfunction as well as minor erectile dysfunction. The vibratory device can be used for providing a massage to the entire body, optionally also using oil.

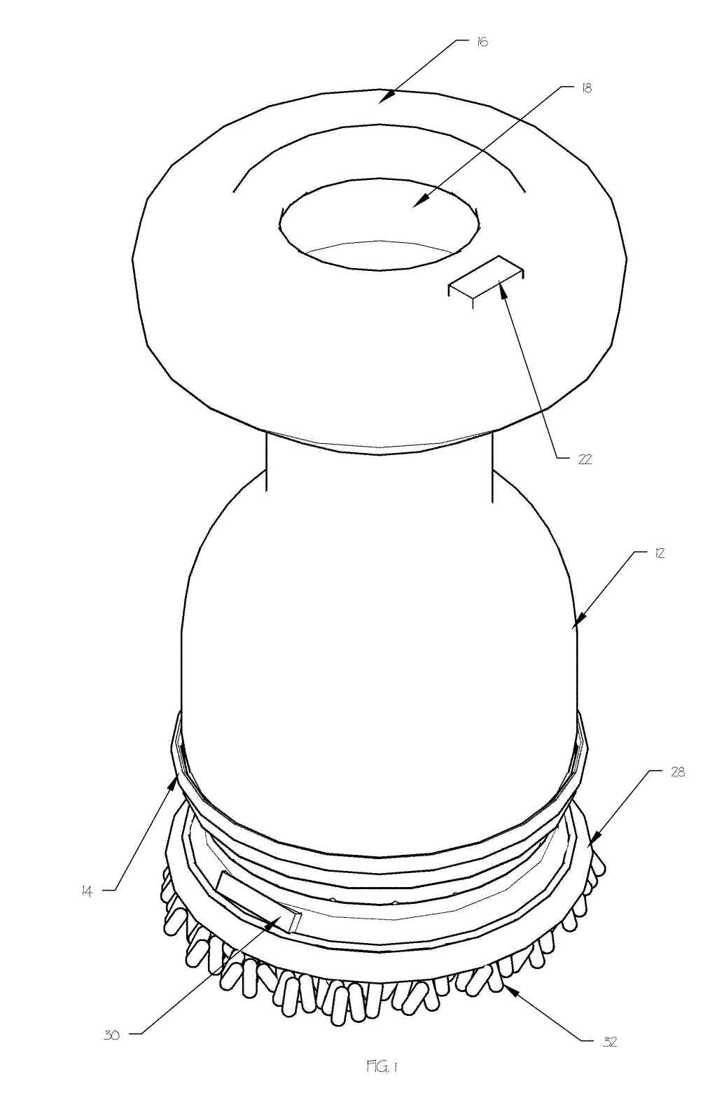

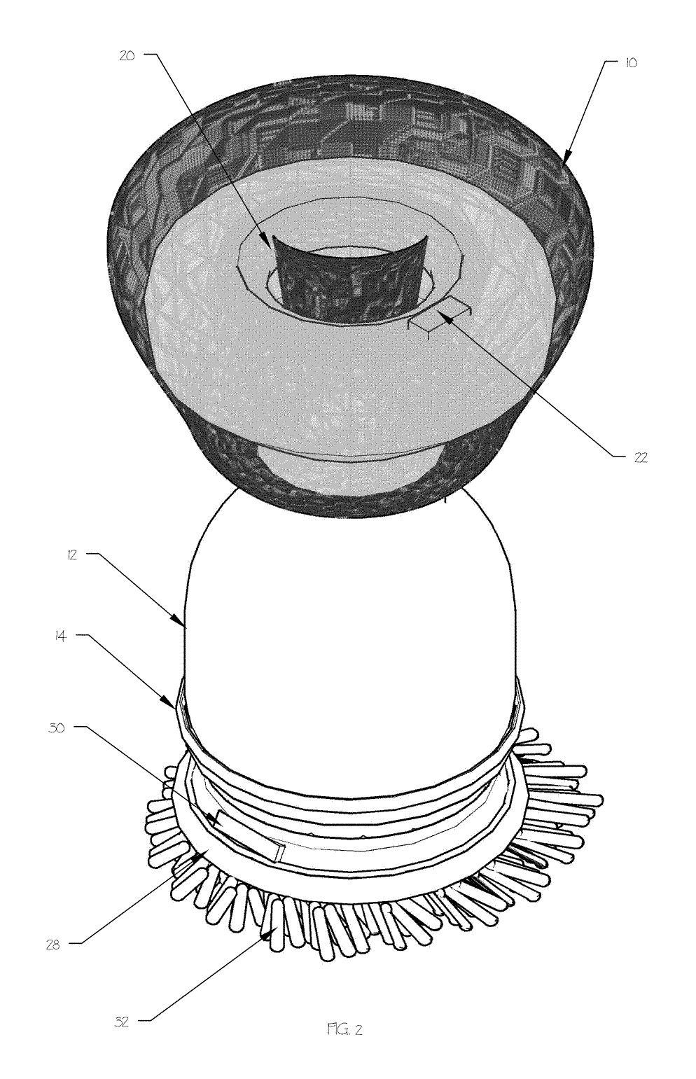

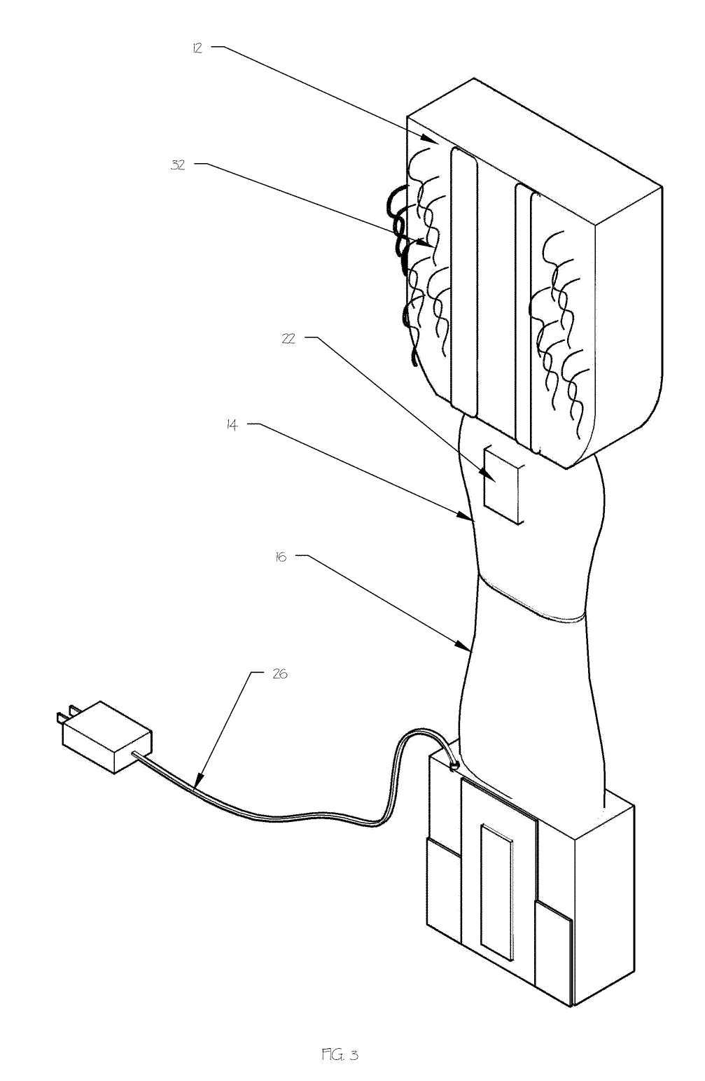

The vibratory device of the present invention is generally constructed as shown in FIG. 1-3, and referred by numeral 10. The vibratory device 10 generally comprises a body 12. A vibrating plate 14 is mounted on the body 12. The body 12 further has a hand grip region 16. The hand grip region 16 is designed to allow a firm grip on the body 12. In a preferred embodiment of the present invention shown in FIG. 1, the vibratory device 10 has an elongated body 12, the vibrating plate 14 is present on lower end of the body 12, the hand grip region 16 is present on the upper end of the body 12 and shaped as a handle region with an opening 18 adapted to receive four fingers of a hand allowing a firm grip on the body 12 while using the vibratory device 10. The hand grip region 16 may also be optionally covered with a silicone layer 20 which is present over the entire hand grip region 16 as well as the opening 18 in the hand grip region 16 as shown in FIG. 2. The silicone layer 20 functions as a cover which allows a comfort feel to the user while the user inserts one hand into the opening 18 and optionally applies another hand over the hand grip region 16 for pushing the vibratory device 10 onto the groin or other skin. The silicone layer 20 can be applied with oil to give the hands a sensual feeling of vibration and oily silicone which stimulates sexual pleasure. In another preferred embodiment of the present invention shown in FIG. 3, the hand grip region 16 of the vibratory device 10 is shaped as an elongated handle and is at an angle relative to the region of the body 12 containing the vibrating plate 14.

A speed controller 22 is installed_near the hand grip region 16 so that the thumb of a user easily reaches the speed controller 22 when the user places a hand at the hand grip region 16. The speed controller 22 provides an option to select different speed levels for vibration generated in said vibrating plate 14. The body 12 houses a power source connected to an electric motor. The electric motor is operationally connected to the vibrating plate 14 to generate vibrations in the vibrating plate 14. The electric motor used in the vibratory device 10 is a 2 amp motor. The power source in the body 12 is a battery 24 to supply power to the electric motor. The electric motor housed in the body 12 can also be connected to an external power supply by an electric cord 26.

In a preferred embodiment of the present invention, the vibratory device 10 is further provided with a massage pad 28 adapted to be removably attached over the vibrating plate 14. The massage pad 28 is attached to the vibrating plate 14 preferably by a clip on attachment 30. The massage pad 28 absorbs the vibration generated in vibrating plate 14. The massage pad 28 is preferably made of sponge or rubber. The provision of attachable massage pad 28 in the vibratory device 10 allows the user to use high-intensity vibration directly from the vibrating plate 14 when massage pad 28 is not attached to the vibrating plate 14 and also use low-intensity vibration when massage pad 28 is attached to the vibrating plate 14. The vibratory device 10 having massage pad 28 attached to the vibratory plate 14, can be directly used over clothes covering a skin.

In another preferred embodiment of the present invention, a soft elastomeric material 32 that is intended to emulate the feel of human skin, is warm and soft to touch, and available with brand name CyberSkin®, can be removably attached to the massage pad 28 attached on the vibrating plate 14 of the vibratory device 10. Many other soft elastomeric material similar to CyberSkin® are available in the market by names Ultraskin™, Eroskin™, Softskin™, SoftTouch™, Cyber Jel-lee™ New Supersoft™, Futurotic®, and URL™ (Ultra Realistic 3.0) and can be used with the vibratory device 10 of the present invention. The soft elastomeric material 32 can be attached to the massage pad 28 by a hook and loop fastener preferably by Velcro. The soft elastomeric material 32 can be optionally lubricated with oil for creating stimulation and sensation to the skin being massaged with the vibratory device 10 with the soft elastomeric material 32 in contact with the skin. The present invention may also use other material made of gel, rubber, silicone and the like in place of soft elastomeric material 32 (CyberSkin®). The soft elastomeric material 32 i.e gel, rubber, silicone and the like are used in different textures and colors with the vibratory device 10 of the present invention.

The vibratory device is preferably 17 inches long, 6.5 inches wide and 9.5 inches high. The vibratory device weighs 4.5 to 5.5 lbs. The vibratory device is durable. The body of the vibratory device is preferably made from plastic or flax.

It is to be understood that the above description is intended to be illustrative, and not restrictive. For example, the above-discussed embodiments may be used in combination with each other. Many other embodiments will be apparent to those of skill in the art upon reviewing the above description.

Whereas the construction and method have been described in relation to the figures of the drawings, it should be understood that other and further modifications, apart from those shown or suggested herein, may be made within the spirit and scope of this invention.

What is claimed is:

1. A vibratory device for providing vibration to stimulate erogenous zones, said vibratory device comprising:
a body housing a power source and a motor, said power source supplying power to said motor;
a vibrating plate present on said body, said motor operationally connected to said vibrating plate to generate vibration in said vibrating plate;
a hand grip region on said body, said hand grip region designed to allow a firm grip on said body;
a massage pad removably attached over said vibrating plate, said massage pad adapted to absorb the vibration generated in vibrating plate;
a speed controller present on said body to select different speed levels for vibration generated in said vibrating plate;
wherein said vibratory device is adapted to be used directly in contact with skin or over clothes for application of vibrations generated in said vibrating plate to the skin.

2. The vibratory device of claim 1, wherein said vibratory device has an elongated body, said vibrating plate present at lower end of said body, said hand grip region present at upper end of said body.

3. The vibratory device of claim 1, wherein said hand grip region shaped as a handle region with an opening adapted to receive four finger of a hand allowing a firm grip on the body.

4. The vibratory device of claim 1, wherein said hand grip region is shaped as an elongated handle and present at an angle relative to the region of said body containing said vibrating plate.

5. The vibratory device of claim 1, wherein said hand grip region is further covered with a silicone layer present over the entire hand grip region.

6. The vibratory device of claim 1, wherein said hand grip region shaped as a handle region with an opening adapted to receive four finger of a hand allowing a firm grip on the body, said hand grip region further covered with a silicone layer present over the entire hand grip region as well as the opening in the hand grip region.

7. The vibratory device of claim 1, wherein said speed controller is present near said hand grip region.

8. The vibratory device of claim 1, wherein said massage pad is attached to said vibratory pad by a clip on attachment.

9. The vibratory device of claim 1, wherein said massage pad is made of sponge.

10. The vibratory device of claim 1, wherein said massage pad is made of rubber.

11. The vibratory device of claim 1, wherein said vibratory device further includes a soft elastomeric material removably attached to said massage pad.

12. The vibratory device of claim 11, wherein said soft elastomeric material is CyberSkin®.

13. The vibratory device of claim 11, wherein said soft elastomeric material attached to said massage pad by Velcro.

14. The vibratory device of claim 1, wherein said vibratory device further includes a material removably attached to said massage pad, wherein said material is made of IE jelly.

15. The vibratory device of claim 1, wherein said vibratory device further includes a material removably attached to said massage pad, wherein said material is made of rubber.

16. The vibratory device of claim 1, wherein said vibratory device further includes a material removably attached to said massage pad, wherein said material is made of silicone.

17. The vibratory device of claim 1, wherein said vibratory device is 17 inches long, 6.5 inches wide and 9.5 inches high.

18. The vibratory device of claim 1, wherein said vibratory device weighs 4.5 to 5.5 lbs.

19. The vibratory device of claim 1, wherein said body is made from plastic.

20. The vibratory device of claim 1, wherein said body is made from flax.
